(19) United States
(12) Patent Application Publication
(10) Pub. No.: US 2007/0097274 A1
(43) Pub. Date: May 3, 2007

(54) Television remote control location

(75) Inventor: Andrew K. Pfiffer, Aloha, OR (US)

Correspondence Address: Richard Calderwood;Stexar Corp., #100, 20400 NW Amberwood, Beaverton, OR, 97006-7099, US

(73) Assignee: Stexar Corp.

(21) Appl. No.: 11/266,895

(22) Filed: Nov. 3, 2005

(51) Int. Cl. H04N 5/44

(52) U.S. Cl. 348/734

(57) ABSTRACT

A television system includes a wireless transmitter in the television set and a wireless receiver in the remote control unit. The television set includes a mechanism such as a button or a menu item which the user can activate, causing the television set to send a signal to the remote control unit. In response to receiving that signal, the remote control unit makes a sound, emits a light, and/or vibrates, enabling the user to locate the remote control unit.

### BACKGROUND OF THE INVENTION

1. Technical Field of the Invention

This invention relates generally to televisions and remote control units for televisions, and more specifically to means for a user to locate a misplaced remote control unit.

2. Background Art

Virtually all television sets are now supplied with wireless remote control units whereby a user may operate the various controls of the television set without being in immediate proximity to the television set. These remote control units communicate via a one-way wireless link to their television sets. The link is one-way in that the remote control unit contains only a transmitter and not a receiver. The wireless like may communicate via e.g. radio frequency (RF), infrared (IR), or other means.

A few “universal” remote control units have been known to be equipped with a transmitter for sending signals to the television, as well as a receiver for receiving signals from another remote control. This enables the universal remote to learn how to emulate the other remote control unit, by associating particular buttons with digital values transmitted by the other remote when corresponding buttons are pressed by the user. Thereafter, the user can use the universal remote to control the appliance (DVD player, stereo, what have you) which came with the other remote, which can now be put in a drawer and forgotten.

Users often misplace remote control units. Owing to their relatively small size, remote control units can be difficult to then locate, as they fit readily under furniture, under sofa cushions, behind bookshelves, and so forth.

Cordless telephone handsets are similarly sized, and just as easily misplaced. Handsets are necessarily equipped with bidirectional communication links with their base stations, so the user can both speak and listen over the wireless link. Handsets are also equipped with audio transducers, such as small loudspeakers and/or piezoelectric transducers, for playing voice signals and e.g. ring tones. Many base stations are now equipped with a “find handset” button. When the user presses this button, the base station sends a predetermined signal to the handset via the conventional, existing wireless link. Upon receiving this signal, the handset generates an audible sound via its output transducer, enabling the user to find the handset. This system works because the handset not only has a wireless receiver and an audio output transducer, but further because the handset is actively monitoring the receiver to detect incoming telephone calls from the base station.

What is desirable is an improvement in televisions and their remote control devices enabling the user to locate a lost remote control device.

### BRIEF DESCRIPTION OF THE DRAWINGS

FIG. 1 shows a television and remote control unit according to one embodiment of this invention.

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

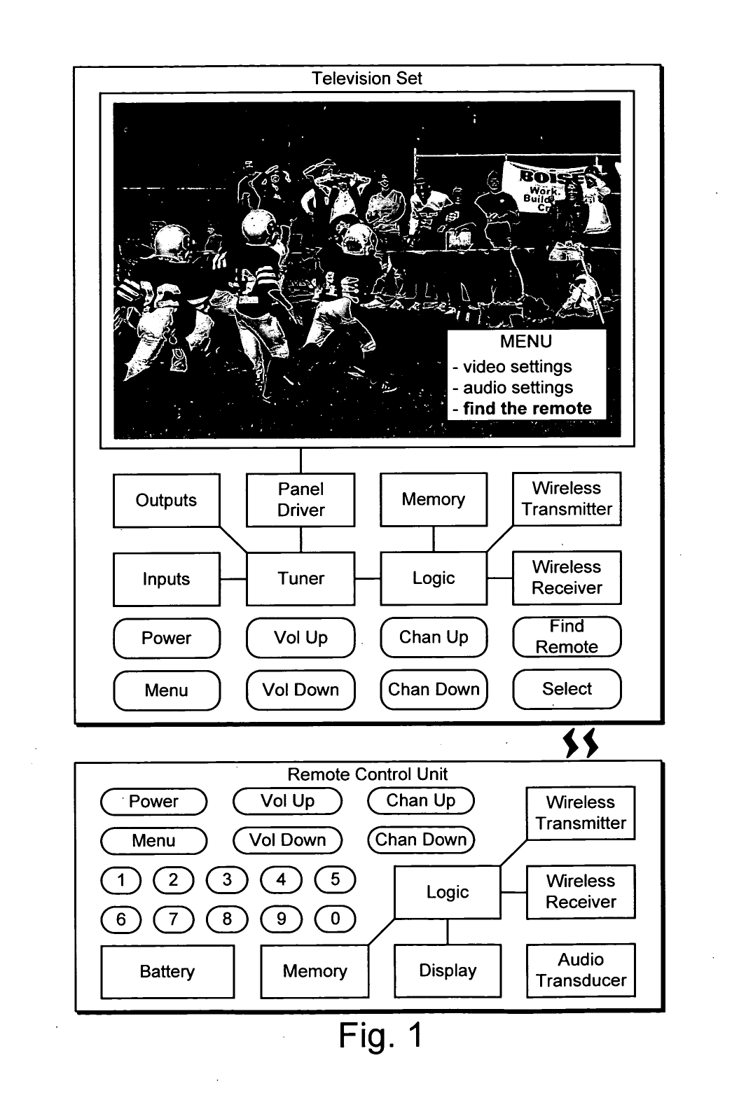

FIG. 1 illustrates a television system including a television set and a remote control unit. The television set includes a display panel illustrated as presenting an image from a football game broadcast. The television set further includes a tuner for receiving and decoding a broadcast received at one of several inputs, and a panel driver for generating appropriate signals for presenting that broadcast on the display panel. The television set includes logic, such as a programmable microprocessor or digital signal processor, coupled to memory for storing instructions, data, frame buffers, and the like. The television set may also include one or more outputs for connecting to other devices such as audio amplifiers. The television set typically also includes a plurality of buttons via which the user may control operation of the television set, such as a power button, volume up and down buttons, channel up and down buttons, a menu button and a select button for performing on-screen menu functions. The television set is equipped with a wireless receiver for receiving signals from the remote control unit.

The remote control unit includes logic such as a microprocessor, an ASIC, or the like for performing logic and control functions, and memory for holding instructions and data for those functions. Some remote control units include a small display for presenting data to the user. A battery supplies electric power for the remote control unit. The remote control unit further includes a plurality of buttons which the user can press to send predetermined signals to the television set via a wireless transmitter of the remote control unit. The memory holds the values of the signals to be sent. For example, when the user presses the channel up button, the logic may retrieve the value 0×551F from the memory and send that value to the television set via the wireless communication link between the remote control unit's wireless transmitter and the television set's wireless receiver.

The present invention adds a wireless transmitter to the television set and a wireless receiver to the remote control unit, for establishing a link in the other direction. In some embodiments, each component's transmitter and receiver may be implemented as a single transceiver. The invention further adds to the television set means whereby the user can cause the television set to send a “Identify Your Location” signal to the remote control unit, and further adds to the remote control unit means whereby the remote control unit enables the user to find it.

In one embodiment, the television set thus includes a “Find Remote” button which the user can press to cause the “Identify Your Location” signal to be sent. In another embodiment, the television set's on-screen menu system includes a selectable “Find Remote” item which the user can select via the buttons on the television set, to cause the “Identify Your Location” signal to be sent. In some embodiments, the television set may include both a button and a menu item for sending the signal.

In one embodiment, the remote control unit thus includes an audio transducer such as a small loudspeaker or a piezoelectric transducer, which the logic causes to play some predetermined sound in response to receiving the “Identify Your Location” signal. In another embodiment, the remote control unit includes a vibrating mechanism such as found in pagers and cell phones. In yet another embodiment, it includes a bright light source such as a cluster of LEDs. In some such embodiments, it may include light sources on more than one surface, in case it is face-down and one of the light sources is not visible to the user. These vibrating and visual mechanisms are useful for hearing impaired users. In some embodiments, the remote control unit may include a combination of audio, vibrating, and/or visual location mechanisms. Other visual mechanisms may include moving parts, such as flags, which may wave or which may even cause the body of the remote control unit to move sufficiently for the user to detect its motion.

Adding a receiver to the remote control unit will tend to increase its battery consumption. A conventional remote control consumes extremely little power except when actually sending a signal, because it only needs to have enough circuitry “alive” to check whether the user has pressed a button. But with the addition of the present invention, the remote control unit needs to more or less continuously monitor the receiver to see if the television set has sent the “Identify Your Location” signal. This will shorten the charge life of the battery. One way of compensating is to use a larger battery.

One way of minimizing the battery life impact is to reduce the frequency at which the remote control unit activates its receiver. Rather than continuously listening for a sent-once signal, the system can be implemented such that the television set sends the “Identify Your Location” signal repeatedly for some predetermined time, such as four seconds, and such that the remote control unit samples at least once per that amount of time. Alternatively, or additionally, the television set may send the signal repeatedly until it receives an acknowledgement signal back from the remote control unit. Or, the remote control unit could periodically send an “Are You Looking For Me” signal to the television set, then listen for a brief period for a “Yes I Am” reply.

### Conclusion

The various features illustrated in the figures may be combined in many ways, and should not be interpreted as though limited to the specific embodiments in which they were explained and shown.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A television system comprising:
a television set including,
a display panel,
panel driver means for providing video signals to the display panel,
logic for performing control functionalities of the television set,
a wireless receiver coupled to the logic,
a wireless transmitter coupled to the logic, and
means, coupled to the logic, for causing an “Identify Your Location” signal to be sent via the wireless transmitter; and
a remote control unit including,
a plurality of user operable buttons,
logic for performing control functionalities of the remote control unit,
a wireless transmitter for sending signals to the wireless receiver of the television set in response to the user operating the buttons,
a wireless receiver for receiving the “Identify Your Location” signal from the television set, and
means for enabling the user to locate the remote control unit in response to receipt of the “Identify Your Location” signal by the remote control unit.

2. The television set of claim 1 wherein:
the means for causing the “Identify Your Location” signal to be sent comprises a user operable button.

3. The television set of claim 1 wherein:
the means for causing the “Identify Your Location” signal to be sent comprises a menu item.

4. The television system of claim 1 wherein:
the means for enabling the user to locate the remote control unit comprises an audio transducer.

5. The television system of claim 1 wherein:
the means for enabling the user to locate the remote control unit comprises a vibrating mechanism.

6. The television system of claim 1 wherein:
the means for enabling the user to locate the remote control unit comprises a light source.

7. An improvement in a television system, the television system including a television set and a remote control unit, wherein the improvement comprises:
a wireless receiver in the remote control unit for receiving a predetermined signal from the television set;
means in the remote control unit for enabling a user to locate the remote control unit in response to receipt of the predetermined signal;
a wireless transmitter in the television set;
means in the television set whereby a user can cause the television set to send the predetermined signal via the wireless transmitter.

8. The improvement of claim 7 in the television system, wherein:
the means in the remote control unit for enabling the user to locate the remote control unit comprises an audio transducer.

9. The improvement of claim 7 in the television system, wherein:
the means in the remote control unit for enabling the user to locate the remote control unit comprises a vibrating mechanism.

10. The improvement of claim 7 in the television system, wherein:
the means in the remote control unit for enabling the user to locate the remote control unit comprises a light source.

11. The improvement of claim 7 in the television system, wherein:
the means in the television set whereby the user can cause the television set to send the predetermined signal comprises a button.

12. The improvement of claim 7 in the television system, wherein:
the means in the television set whereby the user can cause the television set to send the predetermined signal comprises a menu item.

13. A method of locating a television set's remote control unit, the method comprising:
a user activating a first mechanism of the television set;
in response to the user activating the first mechanism, the television set sending a wireless signal to the remote control unit;
the remote control unit receiving the wireless signal; and
in response to receipt of the wireless signal, a second mechanism in the remote control unit producing a stimulus detectable by the user.

14. The method of claim 13 wherein:
the user activating the first mechanism comprises the user pressing a button on the television set.

15. The method of claim 13 wherein:
the user activating the first mechanism comprises the user selecting a menu item from an on-screen menu on the television set.

16. The method of claim 13 wherein:
the second mechanism producing the stimulus comprises an audio transducer on the remote control unit generating sound.

17. The method of claim 13 wherein:
the second mechanism producing the stimulus comprises a vibrating mechanism on the remote control unit vibrating.

18. The method of claim 13 wherein:
the second mechanism producing the stimulus comprises a light source on the remote control unit emitting light.
